(19) United States
(12) Patent Application Publication
(10) Pub. No.: US 2013/0307689 A1
(43) Pub. Date: Nov. 21, 2013

(54) Calculatore string measurer

(71) Applicant: Yaakov Elchonon Oppen, Baltimore, MD (US)

(72) Inventor: Yaakov Elchonon Oppen, Baltimore, MD (US)

(21) Appl. No.: 12/807,174

(22) Filed: Oct. 25, 2010

Related U.S. Application Data
(60) Provisional application No. 61/340,551, filed on Mar. 18, 2010.

(51) Int. Cl. G08B 21/00

(52) U.S. Cl. 340/540

(57) ABSTRACT

This patent is claim to a wheel that spins to a calculator and adds or minuses based on the button pressed to a calculator that has its inner button set on 1+1 or 1−1. The calculator later copies that number or it can be put in and copied or from computer. When that number is later found it will alarm person or project to screen picture or text. this mechanism can be used in measuring or in a scale weighing . In measuring your place on a computerized map based upon where you turn the wheel or compose and by knowing and calculating your speed and place. This mechanism is good where ever you put it.

The calculator string measurer.

Is a measurer that calculates when measuring what you measure via clicking the equals sign=for either plus or minus of 1+1 on the calculator while your measuring done via flicking the button with the motion of movement of the wheel that has etches in it. It should also have a hook on it that goes up like an antenna for measurement of waist or/and when you want to put it higher or out as well as a pen. and then a normal calculator that's attaches also to a computer to copy and delete and type in sizes that will alarm by beep when wave found and write stop on it when designed number was reached.

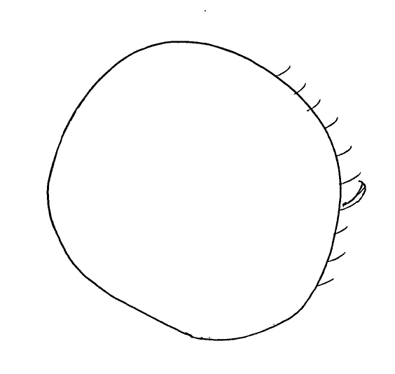

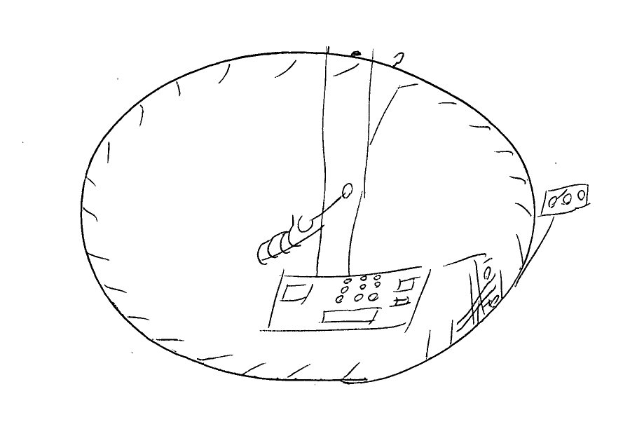

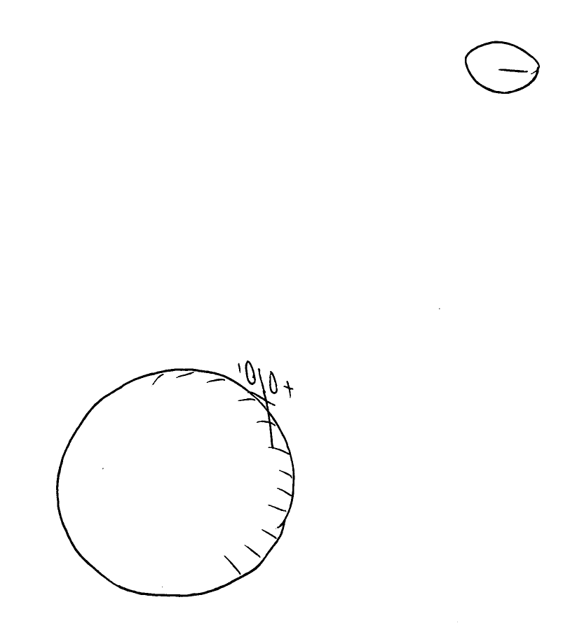

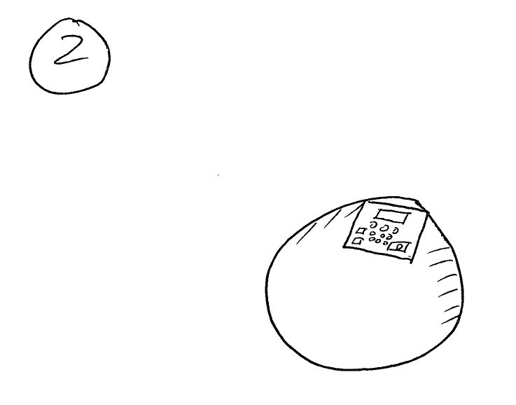

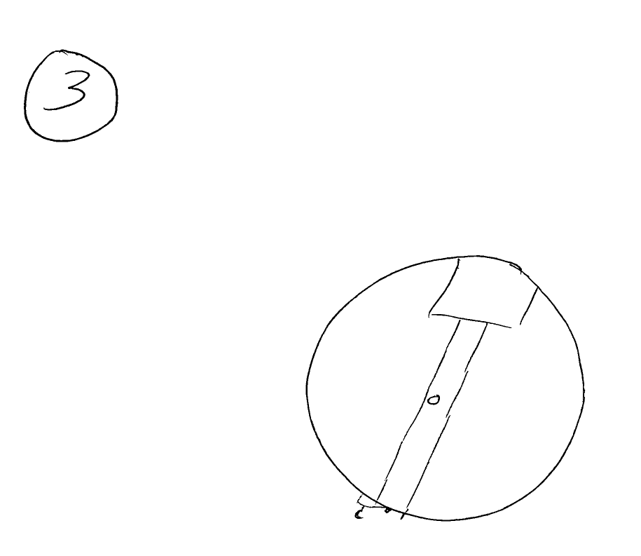

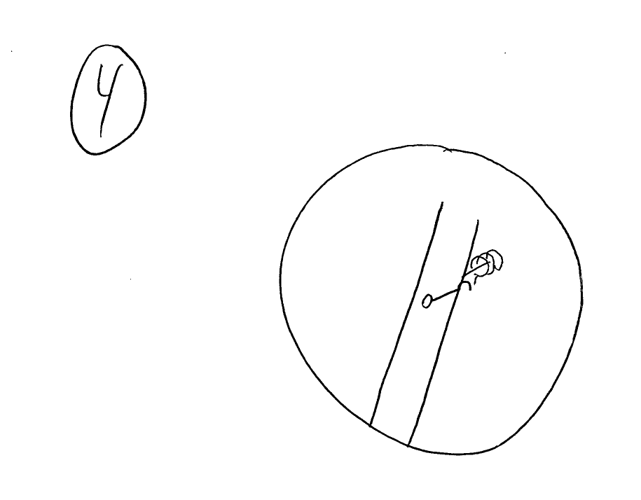

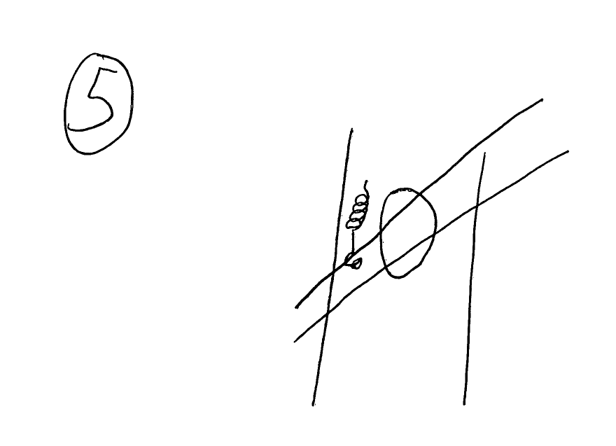

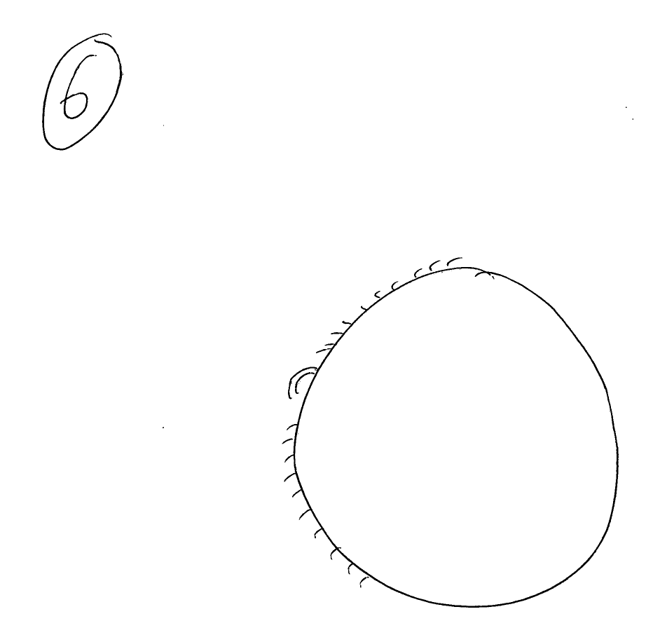

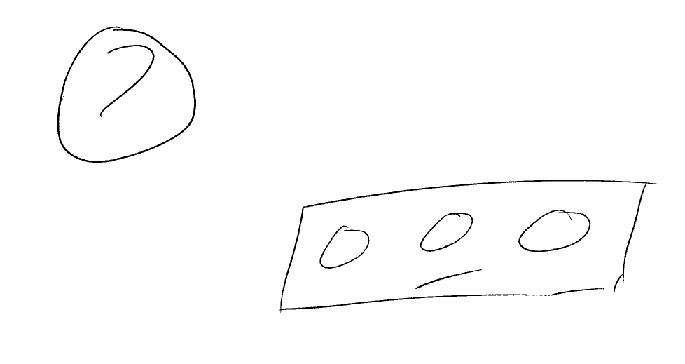

This is how it will work the wheel will have in it etches as much as possible to flick the button on either side to the equals of either plus or minus as depicted in FIG. 1 where you can see the wheel ,piece and button. The calculator will later divide the number into inches and could be copied or deleted and alarmed as depicted in FIG. 2 where you see the calculator and buttons. On one side will be the hook with its antenna and on the other side a pen see FIG. 3 where you see the 2 pieces on both sides of it. in the middle should be a spring that when using the string will go inwards or outwards to pull string back when used and a piece in it [with a hook] that goes in and then out when not in use or when you use the wheel itself. As depicted n FIG. 4 where you see the spring and piece in it. The middle button piece could be held straight by a rubber a spring or just by its natural self see FIG. 5. The wheel could have bumps on it or 2 hooks to place the string back nicely see FIG. 6. On the end piece should be 1 hole and could be 3 and it could have a prick on the end to stick in wood or piece as seen in FIG. 7 where you see the piece with 3 hole and prick.

My claim to this is that it is my original idea for a wonderful new light and easier way to work in always of measuring.

The calculator string measurer.

Is a measurer that calculates when measuring what you measure via clicking the equals sign=for either plus or minus of 1+1 on the calculator while your measuring done via flicking the button with the motion of movement of the wheel that has etches in it. It should also have a hook on it that goes up like an antenna for measurement of waist or/and when you want to put it higher or out as well as a pen. and then a normal calculator that's attaches also to a computer to copy and delete and type in sizes that will alarm by beep when wave found and write stop on it when designed number was reached.

This is how it will work the wheel will have in it etches as much as possible to flick the button on either side to the equals of either plus or minus The calculator will later divide the number into inches and could be copied or deleted and alarmed On one side will be the hook with its antenna and on the other side a pen In the middle should be a spring that when using the string will go inwards or outwards to pull string back when used and a piece in it [with a hook] that goes in and then out when not in use or when you use the wheel itself. The middle button piece could be held straight by a rubber a spring or just by its natural self The wheel could have bumps on it or 2 hooks to place the string back nicely On the end piece should be 1 hole and could be 3 and it could have a prick on the end to stick in wood or piece.

This specification is the same as the other without the figures and numbers of such. My claim to this is that it is my original idea for a wonderful new light and easier way to work in always of measuring.

This is a measurer together with a calculator to interact in all ways and be a light interesting and easier way to measure things. They interact by calculating via wheel pushing piece via etches in it that pushes the button on the calculator to the equals of plus or minus and then divides it to inches and could be used to copy then delete and could alarm person and show stop on alarm wave.

1. My claim to this mechanism is that it is my original idea of adding a calculator and copying device to later project or alarm in conjunction with outside button. And it will help people in more then one way.
